(19) United States
(12) Patent Application Publication
(10) Pub. No.: US 2011/0170213 A1
(43) Pub. Date: Jul. 14, 2011

(54) MAGNETIC RECORDING MEDIUM, MAGNETIC RECORDING APPARATUS EQUIPPED WITH THE MAGNETIC RECORDING MEDIUM, AND TRANSFER MASTER CARRIER

(75) Inventor: Toshihide ISHIOKA, Minamiashigara-shi (JP)

(73) Assignee: FUJIFILM CORPORATION, Tokyo (JP)

(21) Appl. No.: 13/005,204

(22) Filed: Jan. 12, 2011

(30) Foreign Application Priority Data
Jan. 12, 2010 (JP) 2010-003826
Dec. 10, 2010 (JP) 2010-275307

(51) Int. Cl. G11B 5/82; G11B 5/09

(52) U.S. Cl. 360/48; 360/135; G9B/5.293; G9B/5.033

(57) ABSTRACT

A burst included in a burst pattern of a magnetic recording medium is a rectangular region. The rectangular region is constituted by a first signal region formed across a plurality of data tracks and is of a shape in which the length in the down track direction gradually increases in the cross track direction, and a second signal region adjacent to the first signal region in the down track direction. The maximum length of the first signal region is an edge of the rectangular region.

### BACKGROUND OF THE INVENTION

1. Field of the Invention

The present invention is related to a magnetic recording medium. More particularly, the present invention is related to a magnetic recording medium having servo signals for performing servo tracking, a magnetic recording apparatus, and a transfer master carrier equipped with a pattern of protrusions and recesses on the surface thereof as a transfer servo pattern, for forming servo patterns on magnetic recording media.

2. Description of the Related Art

Recently, recording density is increasing in magnetic recording/reproducing apparatuses, in order to realize miniaturization and high recording capacities. Particularly, advances in technology are rapid in the field of hard disk drives, which are representative magnetic recording apparatuses.

Accompanying the increase in recording density, tracks are becoming narrower in hard disks. Discrete track media (DTM) and bit pattern media (BPM) are being focused on. DTM are recording media, in which adjacent data tracks are separated by groove patterns (guard bands) constituted by grooves, to reduce magnetic interference among adjacent tracks, in response to demand for magnetic disk media having higher recording densities. BPM are recording media, in which a magnetic material (single domain magnetic material) that constitutes a single domain is separated into data bits by arrangements of each dot element of a dot pattern, the data bits being physically isolated and arranged regularly to record one bit of data in each single domain magnetic particle.

Servo tracking technology plays a large role in enabling magnetic heads to scan the narrow tracks to reproduce signals with high S/N ratios. A sector servo technique is commonly employed to perform servo tracking.

The sector servo technique is a technique for causing magnetic heads to correct their positions. In the sector servo technique, servo data, such as servo signals, track address data signals, and reproduction clock signals, are recorded in servo fields. The servo fields are provided regularly at predetermined angles on data surfaces of magnetic recording media, such as magnetic disk media. Magnetic heads scan the servo fields and read out the servo data, to confirm and correct their positions.

The magnetic transfer method is a known method for recording servo data (servo patterns) onto conventional magnetic recording media. Magnetic transfer employs patterned master carriers, which have transfer patterns constituted by patterns of protrusions and recesses that correspond to data to be transferred to magnetic recording media (slave media). The master carriers and magnetic recording media are placed in close contact, then recording magnetic fields are applied thereto. Thereby, magnetic patterns that correspond to the servo data recorded by the patterns of protrusions and recesses of the master carriers are magnetically transferred to the magnetic recording media.

Meanwhile, use of an imprinting mold is a method which has been proposed to record servo data onto patterned media, such as DTM and BPM. The imprinting mold is equipped with a pattern or protrusions and recesses corresponding to data to be transferred. Servo patterns are formed as patterns of protrusions and recesses at the same time that groove patterns or bit patterns are formed by the imprint lithography method.

Amplitude servo patterns having four burst bit strings from A through D as burst patterns, and phase servo patterns are known, as described in U.S. Pat. No. 7,652,839.

Position error signals (PES) obtained from amplitude servo patterns are generated at two locations for each track (at 64 PES and 192 PES) at discontinuous points when switching from signals from A-B bursts to signals from C-D bursts (refer to Japanese Unexamined Patent Publication No. 2007-213745).

Phase servo patterns are parallel patterns that extend substantially in the radial direction across a plurality of tracks. Therefore, the number of discontinuous points is less than that of amplitude servo patterns. However, because the phases of sine waves are detected as position error signals, it is necessary for the same pattern to be repetitively provided, and also necessary for inverse phase patterns to be provided.

U.S. Pat. No. 7,203,023 discloses an elongate servo pattern that crosses a plurality of tracks, the length along the circumferential direction of which changes, in the same manner as the change in measured frequencies while scanning a head in the down track direction. U.S. Pat. No. 7,203,023 discloses that in principle, at least two of the elongate patterns are necessary. However, it is necessary for the width of the servo patterns to be approximately 80 clocks in practice, to realize stable tracking.

Accompanying the narrowing of tracks, miniaturization of each individual region of patterns which are formed in servo fields is also progressing. The frequency bands of read channels of magnetic recording apparatuses have increased accompanying the shortening of the bit lengths of data bits. The amplitude servo system and the phase servo system detect amounts of shifting from tracks based on the amplitudes of sine waves and based on phase data obtained from burst sections. In these systems, thinning of patterns that constitute the burst sections is also desired, due to limitations imposed by the increased frequencies of the read channels.

U.S. Pat. No. 7,203,023 describes that the width of a single elongate pattern corresponds to one clock width in the servo system disclosed therein, that is, thinning of the pattern is unavoidable.

Meanwhile, patterns which are not complex are desired, because servo patterns are borne by patterns of protrusions and recesses in master carriers and imprinting molds.

That is, the burst patterns of conventional amplitude servo systems and phase servo systems are becoming drawbacks with respect to the production of magnetic recording media employing transfer master carriers that bear servo patterns as patterns of protrusions and recesses.

### SUMMARY OF THE INVENTION

The present invention has been developed in view of the foregoing circumstances. It is an object of the present invention to provide a magnetic recording medium, on which pattern formation is facilitated, capable of servo control by a simple algorithm, and capable of improving the accuracy of servo tracking. It is another object of the present invention to provide a magnetic recording apparatus equipped with such a magnetic recording medium. It is still another object of the present invention to provide a transfer carrier, such as an imprinting mold and a magnetic transfer master carrier, equipped with a pattern of protrusions and recesses for forming servo patterns on such magnetic recording media.

A magnetic recording medium of the present invention is equipped with a servo pattern, to be utilized in a magnetic recording apparatus that employs a servo method to detect the scanning position of a magnetic head in the radial direction of magnetic recording media, based on integrated values obtained from burst patterns within servo patterns of magnetic recording media, comprising:

the servo pattern; and

the burst pattern including bursts within the servo pattern;

and is characterized by:

each burst being a rectangular region constituted by a first signal region formed across a plurality of data tracks and is of a shape in which the length in the down track direction increases substantially linearly in the cross track direction, and one or two second signal regions adjacent to the first signal region in the down track direction, the maximum length of the first signal region being an edge of the rectangular region; and

a plurality of the bursts being provided in the cross track direction.

Here, the cross track direction includes both the (+) direction in which track numbers increase and the (−) direction in which track numbers decrease (directions towards the inner and outer radial directions of a disk). Accordingly, the expression “the length in the down track direction increases substantially linearly in the cross track direction” refers to the length in the down track direction increasing substantially linearly in either of the cross track directions.

Here, the maximum length of the first signal region refers to the maximum length of the first signal region in the down track direction.

The first signal region and the second signal region are regions that exhibit different magnetic states. These regions may have different magnetized states from each other, or may be constituted by a magnetic region and a non magnetic region.

It is desirable for the shape of the first signal region includes a first edge that intersects with the down track direction and the cross track direction, and a second edge that extends across the plurality of data tracks and is not parallel with the first edge. Here, the edges refer to line segments (of straight lines).

It is also desirable for a plurality of the bursts to be provided in the down track direction. Further, in this case, it is particularly desirable for the plurality of the bursts provided in the down track direction to be provided such that bursts which are adjacent to each other in the down track direction are offset in the cross track direction.

A magnetic recording apparatus of the present invention is characterized by being loaded with the magnetic recording medium of the present invention.

The magnetic recording apparatus employs a servo method to detect the scanning position of a magnetic head in the radial direction of magnetic recording media, based on integrated values obtained from burst patterns within servo patterns of magnetic recording media. The magnetic recording apparatus is equipped with: a storage section, in which integrated burst signal value data for on track states are stored for each track; and a comparing section, for comparing the stored integrated burst signal value data against integrated signal values obtained by scanning the magnetic recording medium with a magnetic head. The magnetic recording apparatus obtains the amount that the magnetic head is off track (hereinafter, also referred to as “off track amount”) based on the comparison, to control the position of the magnetic head.

A transfer master carrier of the present invention is equipped with a pattern of protrusions and recesses on the surface thereof as a transfer servo pattern, for forming a servo pattern for a magnetic recording medium of the present invention, characterized by:

the transfer servo pattern including one of a recess and a protrusion corresponding to the first signal region of the burst of the magnetic recording medium, having a shape in plan view in which the length in the down track direction gradually increases in the cross track direction, across a plurality of data tracks of the magnetic recording medium.

Here, examples of transfer master carriers include: magnetic transfer master carriers, for forming magnetized patterns on magnetic recording media having uniform magnetic layers by magnetic transfer; and imprinting molds equipped with inverted patterns of protrusions and recesses, for transferring patterns of protrusions and recesses onto patterned media, such as discrete track media and bit pattern media, when producing the patterned media.

Note that in the case that the transfer master carrier is a magnetic transfer master carrier, the master carrier may be constituted by: a substrate having a pattern of protrusions and recesses on the surface thereof and a magnetic layer provided on the surface of the pattern of protrusions and recesses; a substrate having a pattern of protrusions and recesses on the surface thereof and a magnetic layer provided only on the surfaces of the protrusions of the pattern; a substrate having a pattern of protrusions and recesses on the surface thereof, a magnetic layer provided only on the surfaces of the protrusions of the pattern, and non magnetic materials embedded within the recesses of the pattern to form a flat surface; or a nonmagnetic substrate having a pattern of protrusions and recesses on its surface and a magnetic layer embedded within the recesses of the pattern to form a flat surface; a flat substrate and a magnetic layer having an uneven pattern on its surface; and the like.

In the case that the transfer master carrier is an imprinting mold for producing discrete track media, protrusions and recesses for forming grooves are provided in addition to the pattern of protrusions and recesses corresponding to the servo pattern. In the case that the transfer master carrier is an imprinting mold for producing bit pattern media, protrusions and recesses for forming independent bits are provided in addition to the pattern of protrusions and recesses corresponding to the servo pattern.

In the magnetic recording medium of the present invention, the burst pattern within the servo pattern includes bursts having the first signal region, formed across a plurality of data tracks and of a shape in which the length in the down track direction increases gradually in the cross track direction. This type of burst pattern enables conversion of the integrated value of signal values obtained at the bursts to the amount that a magnetic head is off track. Therefore, restrictions caused by the frequencies of read channels of magnetic recording apparatuses are not imposed, unlike in the conventional method that obtains amounts that a magnetic head is off track based on sine waveforms. Therefore, the necessity for thinning due to the restrictions imposed by the frequency of a read channel is obviated. In addition, the bursts are of a shape that straddles a plurality of data tracks, and can be constituted by at least one pair of +/− signal regions (a single first signal region and a single second signal region). Therefore, servo regions can be formed comparatively smaller than those of conventional magnetic recording media, thereby relatively increasing the size of data regions, resulting in an improvement in the recording density of the magnetic recording medium.

Thinning of patterns can be suppressed. Therefore, the present invention can be favorably applied to production of magnetic recording media employing transfer master carriers bearing servo patterns as patterns of protrusions and recesses. The present invention enables servo patterns to be formed with high precision.

### BRIEF DESCRIPTION OF THE DRAWINGS

FIG. 1 is a conceptual plan view that illustrates a sector structure of a magnetic recording medium according to a first embodiment of the present invention.

FIG. 2 is a diagram that illustrates a magnified view of portion A of FIG. 1.

FIG. 3 is a schematic diagram that illustrates a second burst pattern.

FIG. 4 is a schematic diagram that illustrates a third burst pattern.

FIG. 5 is a schematic diagram that illustrates a fourth burst pattern.

FIGS. 6A, 6B and 6C are collections of diagrams that illustrate modified bursts.

FIG. 7 is a schematic diagram that illustrates a fifth burst pattern.

FIG. 8 is a schematic diagram that illustrates a sixth burst pattern.

FIG. 9 is a diagram that illustrates examples of detection results of labeled burst signals in a down track direction.

FIG. 10 is a magnified schematic diagram that illustrates a portion of a magnetic recording medium according to a second embodiment of the present invention.

FIG. 11 is a magnified schematic diagram that illustrates a portion of a magnetic recording medium according to a third embodiment of the present invention.

FIG. 12A is a conceptual plan view that illustrates a transfer master carrier according to a fourth embodiment of the present invention.

FIG. 12B is a magnified diagram that illustrates a portion of the transfer master carrier (magnetic transfer master carrier) of FIG. 12A.

FIGS. 13A, 13B, and 13C are diagrams that illustrate the steps of a magnetic transfer method.

FIG. 14 is a magnified diagram that illustrates a portion of a transfer master carrier (nano imprinting mold) according to a fifth embodiment of the present invention.

FIG. 15 is a diagram that illustrates a process of an imprinting method.

FIG. 16 is a diagram that illustrates the schematic structure of a magnetic record reproducing apparatus having a magnetic recording medium of the present invention loaded therein.

### DESCRIPTION OF THE PREFERRED EMBODIMENTS

Hereinafter, embodiments of the present invention will be described with reference to the attached drawings.

### Magnetic Recording Medium According to a First Embodiment

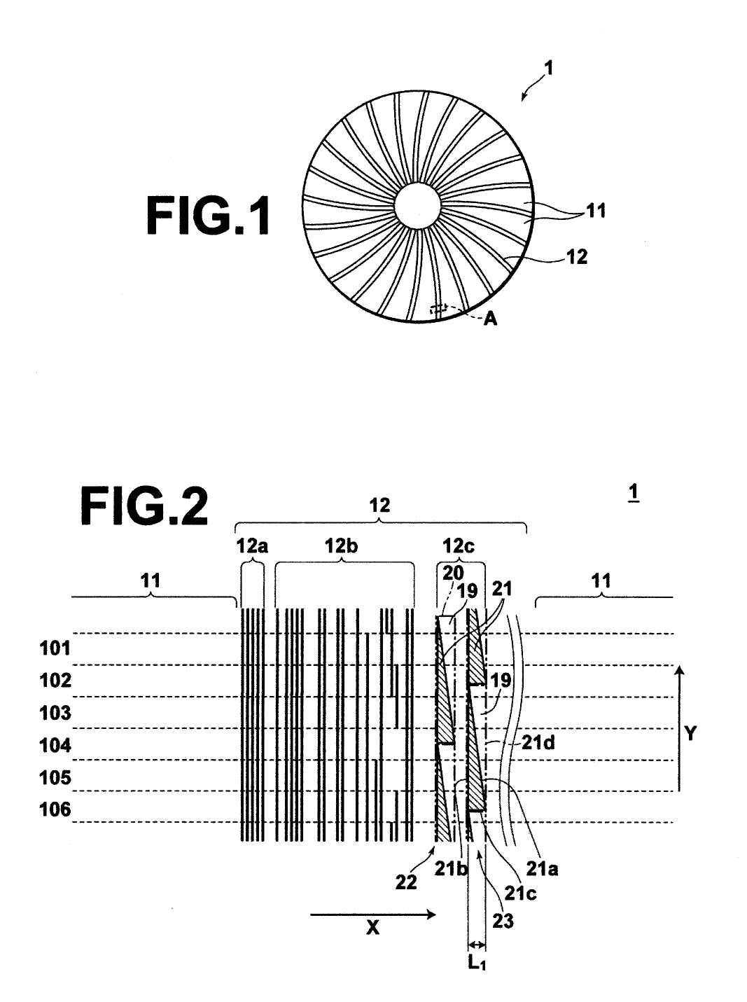

FIG. 1 is a conceptual plan view that illustrates the sector structure of a magnetic recording medium 1 according to a first embodiment of the present invention. The magnetic recording medium 1 of the first embodiment is a magnetic disk medium having a magnetic recording layer uniformly provided on a planar substrate. FIG. 2 is a diagram that illustrates a magnified view of portion A of FIG. 1. Note that in the figures, the circumferential direction of the disk (down track direction) is designated as the X axis and the radial direction of the disk (cross track direction) is designated as the Y axis with respect to the surface of the disk.

As illustrated in FIG. 1, data regions 11 and servo regions 12 are alternately provided in the circumferential direction on the magnetic disk medium 1. That is, the servo regions 12 are intermittently provided within concentric tracks, and the data regions 11 are provided among the servo regions.

The data regions 11 are regions that user data can be written into by a magnetic head of a magnetic recording apparatus.

The servo regions 12 are regions, in which servo data for servo tracking to be performed by the magnetic head are recorded as magnetized patterns.

FIG. 2 is a magnified view of portion A of FIG. 1, and illustrates a portion of a plurality of tracks 101 through 106. A servo pattern constituted by: a preamble portion 12a, for synchronizing a reproduction signal clock; an address portion 12b, in which servo signal discriminating codes, sector data, cylinder data, etc. are formed; and a burst portion 12c, in which burst patterns for detecting positional errors are formed, is provided in the servo region 12. In the servo region 12, the regions indicated by hatching and the white regions (non hatched regions) respectively have magnetic domains of inverse magnetism formed therein. For example, in a vertical magnetic recording medium, if the surfaces of the hatched regions have S polarities, then the surfaces of the white regions have N polarities, and if the surfaces of the hatched regions have N polarities, then the surfaces of the white regions have S polarities.

In the first embodiment, the burst pattern differs greatly from the patterns which are formed on conventional magnetic disks. As illustrated in FIG. 2, the bursts are rectangular regions surrounded by the dashed double dotted lines. Each rectangular region is constituted by a first signal region 21 and a second signal region 19. The shape of the first signal region 21 is a triangle (the hatched region), of which the length in the down track direction increases gradually in the cross track direction, including a first edge 21a that extends across a plurality of data tracks and intersects with the down track direction X and the cross track direction Y, and a second edge 21b that extends across the plurality of data tracks and is not parallel with the first edge 21a. The second signal region 19 is of a triangular shape (the white region) which complements and is combined with the first signal region 21 to form the aforementioned rectangular region.

Here, the length of the first signal region 21 in the down track direction refers to the distance between the first edge 21a and the second edge 21b at the same position in the cross track direction (the same position in the radial direction). In the first embodiment, the maximum length L₁ of the first signal region 21 corresponds to a bottom edge 21c of the triangular shape thereof. The rectangular region of each burst 20 has two parallel edges having the maximum length L₁ of the first signal region 21 in the down track direction, parallel to each other in the down track direction. It is preferable for the width of each burst 20 to be within a range from 4 to 32 clocks.

Note that the dashed double dotted lines that indicate the bursts 20 in FIG. 2 are virtual lines. Because the second signal regions 19 and the region that surrounds the bursts 20 are of the same magnetism, the boundaries between the second signal regions 19 and the surrounding regions indicated by the dashed double dotted lines cannot be visually discriminated in actuality. The same applies to the embodiments following hereafter as well.

In reality, the triangular first signal regions 21 are provided within the burst portion 12c. Here, the virtual rectangular regions that include the first signal regions are defined as the bursts 20.

Note that each burst 20 corresponds to a minimum sampling window during servo tracking using a magnetic recording head of a magnetic recording apparatus or a magnetic recording/reproducing apparatus in which the magnetic recording medium is loaded.

The burst portion 12c includes a first burst string 22, in which the bursts 20 (in reality, the triangular first signal regions 21) are arranged in the cross track direction, and a second burst string 23 provided toward the down track side of the first burst string 22 to cover discontinuous portions among the bursts 20 of the first burst string 22, that is, to cover PES signals for tracks in which positions between adjacent first signal regions 21 of the first burst string 22 are present. The second burst string 23 includes the triangular first signal regions 21 with a constant offset in the cross track direction from the first burst string 22. Note that the burst pattern may include a plurality of pairs of first burst strings 22 and second burst strings 23 which are repetitively provided in the down track direction.

In the case that a preamble period is designated as T, the bursts of a four burst pattern for a conventional amplitude servo system are repetitions of fine patterns having a single servo track width, and lengths on the order of T/2 to T. However, the first signal region 21 of the first embodiment occupies a comparatively large region having widths that straddle a plurality of servo tracks, and lengths of the order of several T's to 10 T.

The first signal regions 21 of the bursts 20 illustrated in FIG. 2 are right triangles, and are arranged such that the edge 21b extends along the cross track direction, and the hypotenuse 21a intersects with both the cross track direction and the down track direction. The length of each first signal region 21 in the down track direction gradually increases in the cross track direction (from track 101 to track 103, for example). That is, the area occupied within each track by the first signal regions 21, which are right triangles, gradually increases in the cross track direction.

The length of the line segments occupied by the first signal regions 21 gradually changes in the cross track direction within the bursts 20 in this manner. Therefore, a magnetic head can derive the amount that it is off track, from integrated values (corresponding to a difference in the hatched regions and the non hatched regions within scanned rectangles), when the magnetic head performs scanning from the edge 21b for a length of the bottom edge 21c of the right triangle (the length of the burst 20 in the down track direction). The first signal regions and the second signal regions are formed with magnetic domains of magnetisms that differ from each other. Therefore, positive (+) signals are obtained from the first signal regions, and negative (−) signals are obtained from the second signal regions, for example. At this time, the amount that the magnetic head is off track can be derived by comparing the integrated value of the signals which are detected when the magnetic head scans the edge of a burst 20 that extend in the cross track direction to the opposing edge of the burst 20 against a signal value which should be output when in an on track state, for each track. In order to perform servo tracking in this manner, a magnetic recording apparatus, in which the magnetic recording medium of the present invention is loaded, may be equipped with: a storage section, in which integrated burst signal value data for on track states are stored for each track; and a comparing section, for comparing the stored integrated burst signal value data against integrated signal values (integrated values) obtained by scanning the magnetic recording medium with a magnetic head.

At positions between adjacent first signal regions 21 in the arrangement in the cross track direction, for example, within track 104, which is a seam between first signal regions 21 of the first burst string 22 in the cross track direction, the change in the length of the line segment occupied by the first signal region is discontinuous. Therefore, it is difficult to detect the amount that a magnetic head is off track from the first burst string 22 in this track.

Therefore, the second burst string 23 is arranged offset from the first burst string in the cross track direction, such that the portions of the first signal regions 21 of the second burst string 23, at which the lengths thereof in the down track direction are gradually changing in the cross track direction, are positioned at the tracks in which positions between adjacent first signal regions 21 of the first burst string 22 are present. Thereby, the positional signal within at least track 104 can be obtained from the second burst string 23.

In the servo pattern of the first embodiment, the burst strings from which PES signals are obtained may be switched every two tracks, such as the first burst string 22 for tracks 101 and 102, the second burst string 23 for tracks 103 and 104, the first burst string 22 for tracks 105 and 106, . . . When switching between burst strings, discontinuities will occur in the PES signals. However, such discontinuities occur at two locations in each track in the conventional amplitude servo patterns having four burst bit strings. In contrast, the burst pattern of the first embodiment can suppress the number of discontinuities to a single location for every two tracks. A case has been described in which each burst straddles four tracks. However, if the bursts are of shapes of which the lengths thereof in the down track direction change continuously over a greater number of tracks (8 tracks or 16 tracks, for example), the switching of burst strings from which PES signals are obtained can be performed every 4 tracks or every 8 tracks, and the occurrence of discontinuities can be further reduced.

### Alternate Examples of Burst Patterns

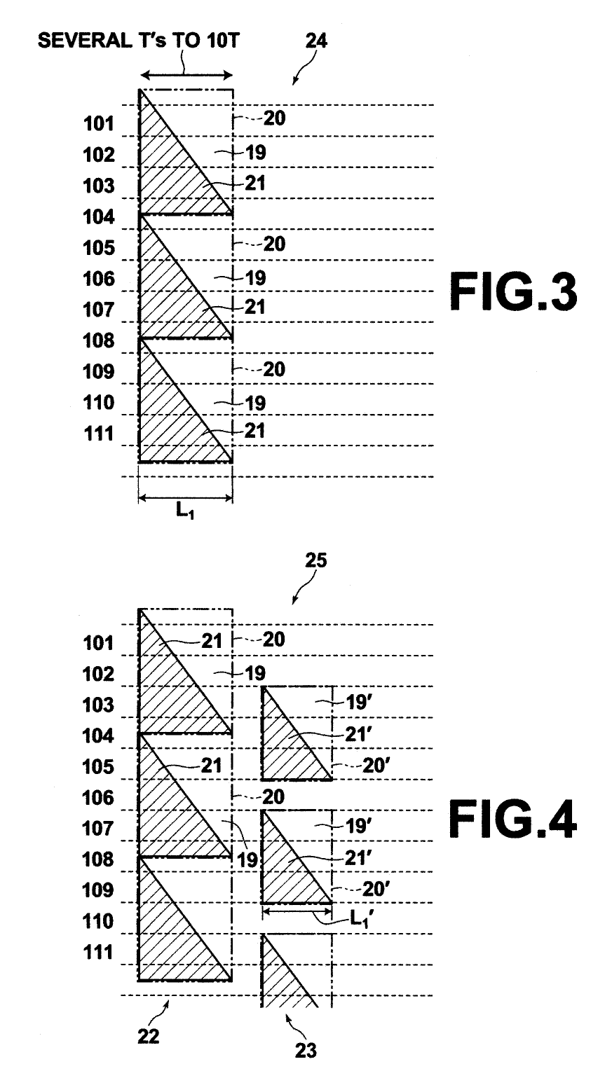

Here, alternate examples of burst patterns of the magnetic recording medium of the present invention will be described with reference to FIG. 3 through FIG. 8. In the drawings, the reference numbers 101, 102, . . . at the left ends thereof denote track numbers.

The burst pattern may be that in which a plurality of triangular first signal regions 21, that is, bursts 20, are arranged in the cross track direction only, as in a second burst pattern 24 illustrated in FIG. 3. However, as described above, there is a possibility that the accuracy of positional control may not be sufficient at the discontinuous portions of the first signal regions 21. Therefore, it is desirable for a second burst string 23 that covers the discontinuous portions to be provided, as illustrated in FIG. 2.

The burst pattern may be that in which first bursts 20 that constitute a first burst string 22 and second bursts 20′ that constitute a second burst string 23 are of different sizes, as in a third burst pattern 25 illustrated in FIG. 4. The second burst string 23 needs only to cover the discontinuous portions of the first burst string 22. Therefore, the second burst string 23 may be offset in the cross track direction with respect to the first burst string 22 such that the lengths in the down track direction of first signal regions 21′ of the second burst string 23 change gradually across the entire widths of tracks in which positions between adjacent first signal regions 21 of the first burst string 22 are present. Thereby, positional signals within at least tracks 104, 108, . . . , at which positions between adjacent first signal regions 21 of the first burst string 22 are present can be obtained from the second burst string 23. Accordingly, further, the shapes of the first signal regions of the first bursts 20 that constitute the first burst string 22 and the second bursts 20′ that constitute the second burst string 23 may also be different.

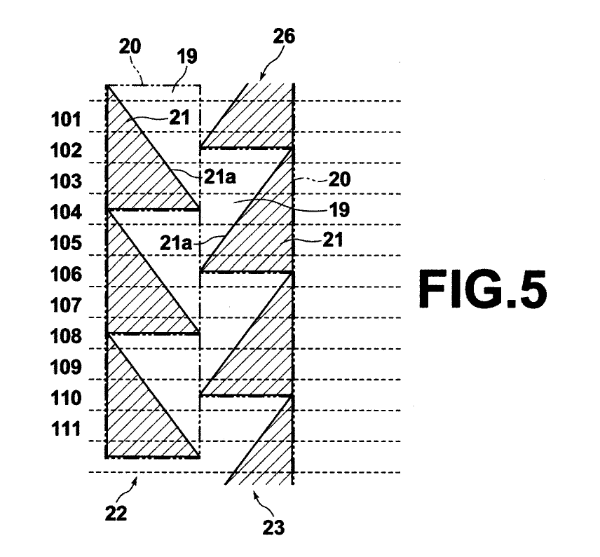

The burst pattern may be that in which first signal regions 21 of a second burst string 23 are horizontally symmetrical with those of a first burst string 22, as in a fourth burst pattern 26 illustrated in FIG. 5.

The shapes of first signal regions within bursts are not limited to right triangles. The first signal regions may be of any shape as long as they are formed across a plurality of data tracks and the lengths thereof in the down track direction gradually increase in the cross track direction.

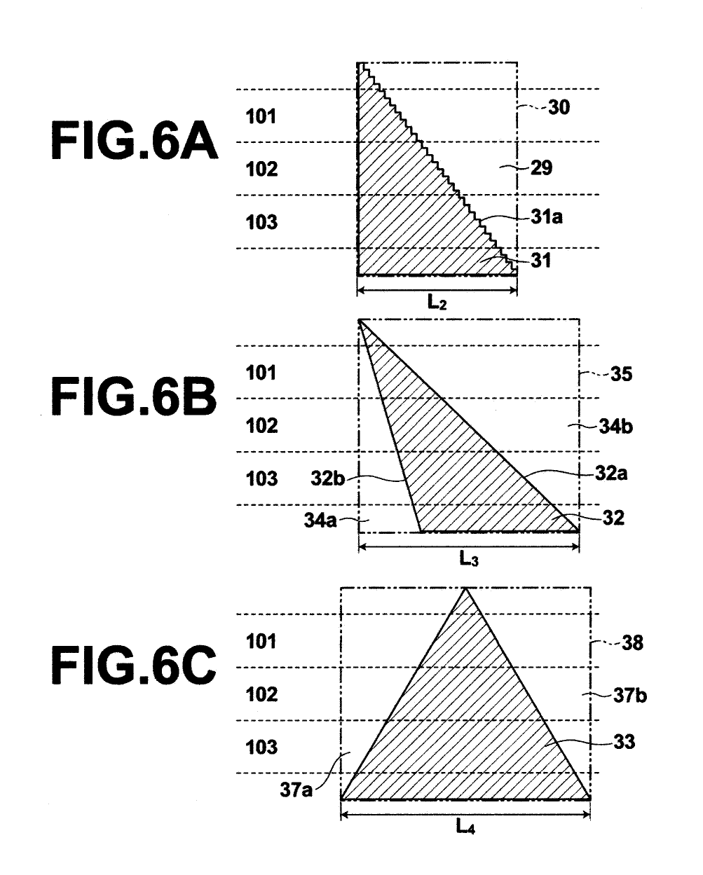

As illustrated in FIG. 6A, a burst 30 is of a rectangular shape formed by a first signal region 31 formed substantially as a right triangle, and a second signal region 29. An edge 31a of the first signal region that crosses the tracks may be formed in a fine stepped shape. If the steps are ½ the track width or less, it is considered that signals will be averaged during signal readout by a magnetic head, and that signals substantially equivalent to those obtained from straight lines will be detected. The burst 30 has an edge parallel to the down track direction having a maximum length L₂ of the first signal region 31 in the down track direction.

As illustrated in FIG. 6B, if two edges 32a and 32b that extend across a plurality of data tracks of a first signal region 32 within a burst 35 are not parallel to each other, the length of the first signal region 32 of the burst 35 changes gradually in the cross track direction. Therefore, the first signal region 32 need not be a right triangle. In this case, the burst 35 is a rectangular region constituted by the first signal region 32 and two second signal regions 34a and 34b arranged at the upstream and downstream sides thereof in the down track direction. In this burst 35, the maximum length of the first signal region 32 in the down track direction is the length L₃ in the down track direction across which the first signal region 32 is present.

Similarly, the first signal region may be an isosceles triangle, such as a first signal region 33 within a burst 38 illustrated in FIG. 6C. Here, the burst 38 is a rectangular region constituted by the first signal region 33 and two second signal regions 37a and 37b arranged at the upstream and downstream sides thereof in the down track direction. In this burst 38, the maximum length of the first signal region 33 in the down track direction is the length L₄ of the bottom edge of the first signal region 33.

In the bursts 30, 35, and 38 as well, the areas occupied by the first signal regions and the second signal regions changes gradually and linearly in the cross track direction. Therefore, integrated signal values can be obtained by scanning a magnetic head, and the amount that the magnetic head is off track can be obtained from differences between the obtained integrated signal values and signal values when in an on track state.

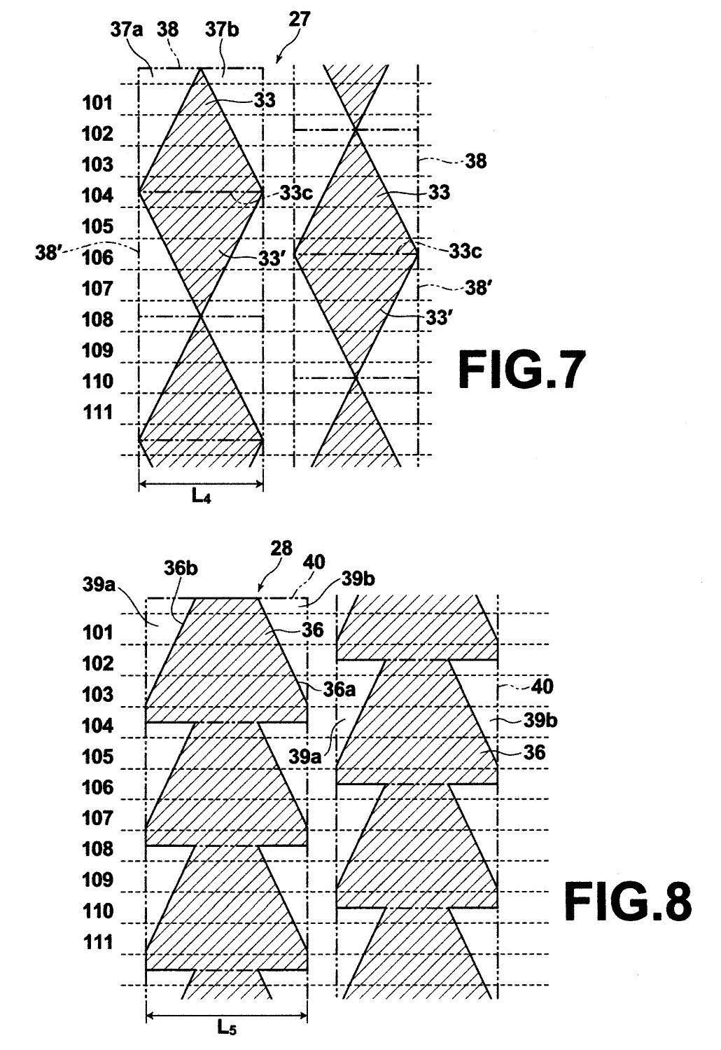

Further, the burst pattern may be that in which first signal regions 33 and 33′, which are isosceles triangles, are stacked in the cross track direction such that their edges 33c overlap, to form diamond shapes, and the diamond shapes are repeatedly arranged in the cross track direction, as in a fifth burst pattern 27 illustrated in FIG. 7. In the fifth burst pattern 27, each of the first bursts 38 is constituted by the first signal region 33 and two second signal regions 37a and 37b adjacent thereto. The first bursts 38 and second bursts 38′, constituted by the first signal region 33′ and two second signal regions 37a′ and 37b′ adjacent thereto, are arranged alternately in the cross track direction.

The first signal regions 33 of the first bursts 38 are isosceles triangles of which the length in the down track direction increases in the positive (+) cross track direction (the direction in which the track number increases). Meanwhile, the first signal regions 33′ of the second bursts 38′ are isosceles triangles of which the length in the down track direction increases in the positive (=) cross track direction (the direction in which the track number decreases).

In addition, the shape of which the length in the down track direction gradually increases need only to be included as a portion of the first signal region. As in a sixth burst pattern 28 illustrated in FIG. 8, the shape of a first signal region 36 of a burst 40 may be that of an isosceles triangle with truncated acute angle corners. In the first signal region 36 of the burst 40 as well, the edges 36a and 36b constitute a shape in which the distance between the edges 36a and 36b (the length in the down track direction) gradually changes across a plurality of tracks (tracks 101 through 103, for example). Here, the burst 40 is a rectangular region constituted by the first signal region 36 and two second signal regions 39a and 39b arranged at the upstream and downstream sides thereof in the down track direction. In the burst 40, the maximum length of the first signal region 36 in the down track direction is the length L₅ of the bottom edge thereof.

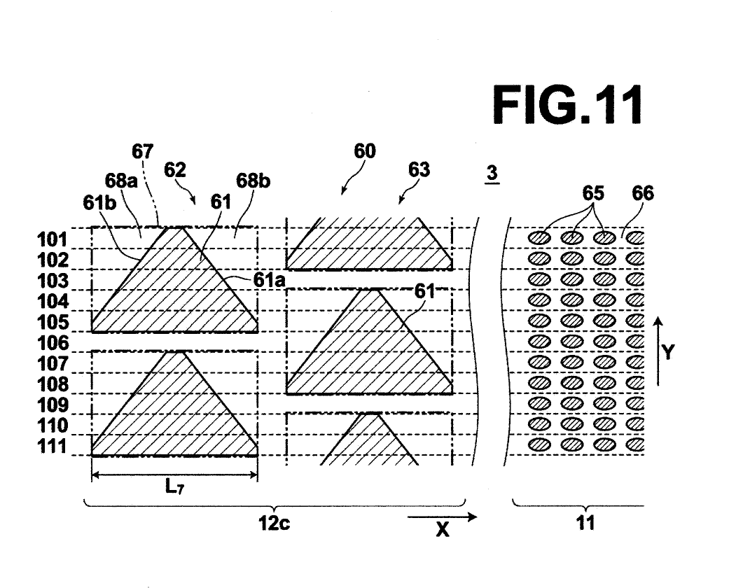

In each of the patterns described above, the bursts arranged in the cross track direction are provided such that they contact adjacent bursts. Alternatively, the bursts may be separated in the cross track direction (refer to FIG. 10 and FIG. 11).

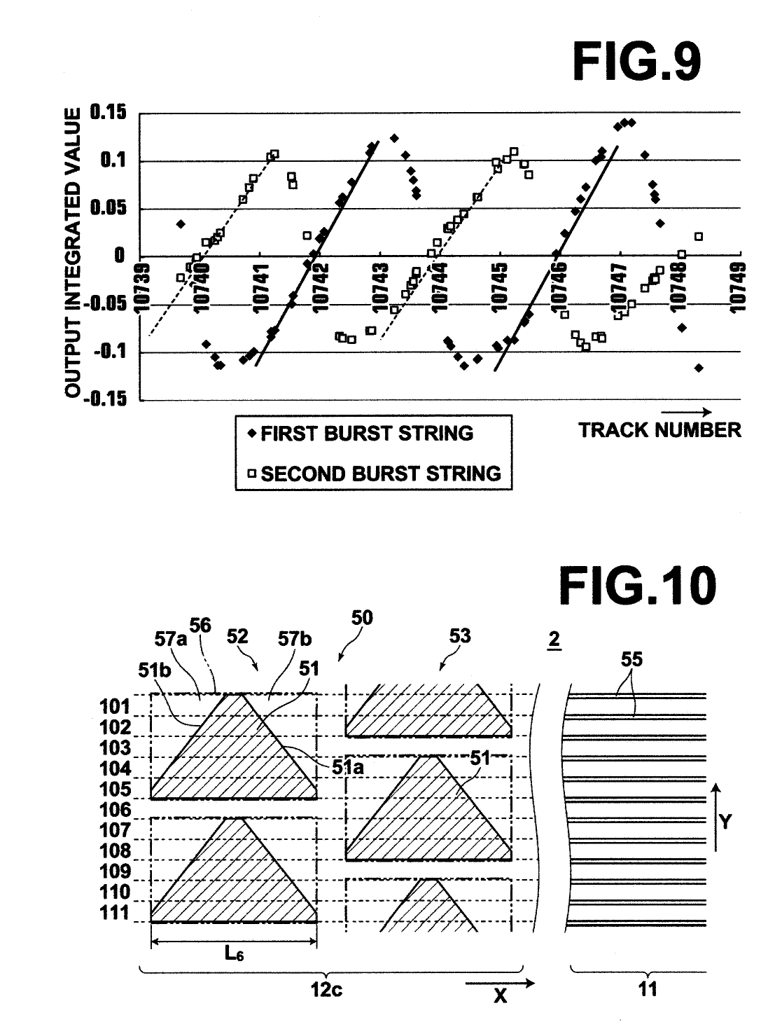

FIG. 9 indicates examples of detection results (experimental results) of integrated labeled burst signals. The detection results are for a case in which the length of the bottom edge 21c (the length in the down track direction) of the right triangle of the burst illustrated in FIG. 2 was set to 8 times the preamble period, and the length of the edge 21a (the length in the cross track direction) was set to 4 times the width of a servo track. In FIG. 9, the horizontal axis represents servo track numbers, and the vertical axis represents output integrated values. As illustrated in FIG. 9, output from the first burst string 22 and the second burst string 23 have alternating linear portions (the linear portions denoted in FIG. 9 by the broken lines and the solid lines). In the example illustrated in FIG. 9, PES signals to be employed may be switched between those obtained from the first burst string and those obtained from the second burst string every two tracks, in order to detect positional errors employing the linear portions. The linearly changing output is due to the fact that the lengths of the first signal regions in the down track direction change linearly.

In the magnetic recording medium equipped with the burst pattern illustrated in FIG. 2, a magnetic head can derive the amount that it is off track, from integrated values (output integrated values), when the magnetic head performs scanning from the edge 21b for the length L₁ of the bottom edge 21c of the right triangle (the length of the burst 20 in the down track direction). As described previously, the signal values themselves, which should be output when in an on track state, or data related to the slopes of the lines of the output integrated values are obtained in advance. Then, the amount that the magnetic head is off track is calculated by comparing the signal value that represent the on track state against the integrated value of the signals which are detected by the magnetic head. By employing the output integrated values that change linearly in the cross track direction, the algorithm for servo tracking can be simplified.

Meanwhile, in actual applications, slight phase shifts (of half a clock or less) occur between a reference clock obtained from the preamble and burst initiation time. Therefore, it is difficult to measure the section between the edge 21b and the edge 21a with a completely accurate initiation timing. In the case that the digital sampling initiation timing of the burst portion begins sampling after the magnetic head has passed over the edge 21b, this will result in erroneous detection of an off track amount, and there is a possibility that tracking accuracy will deteriorate.

As a first method for avoiding erroneous detection of off track amounts, there is that in which the arrangements of bursts and the timing of digital sampling are changed. Specifically, rectangular regions of a uniform polarity having a width of 1 clock or greater may be secured at both sides of the bursts in order to absorb timing errors. The polarity does not matter, as long it is the same at both sides of the bursts. Therefore, white regions (that yield the same signals as the second signal regions) may be secured at both sides of the bursts 20 surrounded by the dashed double dotted lines in FIG. 2. Then, the digital sampling initiation timing is quickened by 1 clock from the first edge 21b of the burst 20 that extends in the cross track direction, and the measurement cessation time is delayed by 1 clock from a second edge 21d of the burst 20 that extends in the cross track direction. Thereby, the burst region is positively secured within the measurement window, and therefore it becomes possible to cancel the effects of timing errors. By adopting this configuration, offsets corresponding to burst signals of the rectangular regions at both sides of the bursts will be generated in the integrated values. However, these offsets are constant amounts that do not depend on off track amounts. Therefore, these offsets can be dealt with by firmware or by setting parameters in advance.

A second method for avoiding erroneous detection of off track amounts is to employ shapes in which neither of the borderlines crosses the tracks perpendicularly, as in the first signal regions 33 of the bursts 38 illustrated in FIG. 7. By adopting this configuration, both of the borderlines are included in the sampling window (within the bursts 38) except at the vicinities of the edges 33c of the triangles. In this case, provision of the regions to absorb timing errors, which is necessary in the first method, is obviated.

### Magnetic Recording Medium According to a Second Embodiment

FIG. 10 is a magnified schematic diagram that illustrates a portion of tracks 101 through 111 of a magnetic recording medium 2 according to a second embodiment of the present invention. The magnetic recording medium 2 of the second embodiment is a discrete track medium (DTM), in which adjacent tracks are separated by non magnetic materials 55 within data regions.

In the DTM 2 as well, the data regions 11 and the servo regions 12 are alternately provided in the circumferential direction, in a manner similar to the magnetic recording medium 1 of the first embodiment.

As illustrated in FIG. 10, the non magnetic materials 55 are provided between tracks within the data regions 11, to separate the tracks. The regions at which the non magnetic materials 55 are provided may be gaps. In the case that the regions are gaps, they are grooves that separate the tracks.

The servo regions of the DTM 2 are regions in which servo data are recorded in advance as patterns of protrusions and recesses. At least the surfaces of the protrusions are formed by a magnetic material.

A plurality of bursts 56 are provided in burst portions 12c within the servo regions. Each of the bursts 56 is constituted by a first signal region 51 and second signal regions 57a and 57b. The first signal region 51 includes a first edge 51a that extends across a plurality of data tracks and intersects with the down track direction X and the cross track direction Y, and a second edge 51b that extends across the plurality of data tracks and is not parallel with the first edge 51a. The second signal regions 57a and 57b are provided adjacent to the first signal region 51 in the down track direction.

In the magnetic recording medium of the second embodiment, the first signal regions 51 are polygons in the shape of isosceles triangles with truncated acute angle corners. In addition, in the second embodiment, the burst portion includes a first burst string 52 and a second burst string 53 provided toward the down track side of the first burst string 52. In the first and second burst strings 52 and 53, the bursts 51 are arranged with one track intervals therebetween in the cross track direction. The second burst string 53 is provided with a constant offset in the cross track direction with respect to the first burst string 52, so as to cover discontinuous portions among the bursts 56 of the first burst string 52 (the position from track 105 to track 107 in FIG. 10, for example), that is, to cover PES signals for tracks in which positions between adjacent first signal regions 51 of the first burst string 52 are present.

In the DTM 2, one of the first signal regions 51 indicated by hatching and the second signal regions (the white regions) is formed by a magnetic material, while the other is formed by a non magnetic material. That is, if the first signal regions 51 are formed by a non magnetic material, the white regions are formed by a magnetic material, and if the first signal regions 51 are formed by a magnetic material, the white regions are formed by a non magnetic material. Here, the regions formed by the non magnetic material may be gaps. That is, the magnetic material regions may be formed as protrusions on the non magnetic material regions. The magnetic material in the servo region is magnetized in a predetermined direction in advance, and different signals can be obtained from the first signal regions and the second signal regions by a magnetic head that performs scanning.

The magnetic head can derive the amount that it is off track, from integrated values (corresponding to differences in the hatched regions and the non hatched regions within scanned rectangles), when the magnetic head performs scanning from the edge 51b for a length L₆ of the bottom edge of the isosceles triangle (the length of the burst 56 in the down track direction), in the same manner as in the magnetic recording medium 1 of the first embodiment.

The DTM 2 may employ first signal regions having the shapes in plan view illustrated in any of FIG. 2 through FIG. 8.

### Magnetic Recording Medium According to a Third Embodiment

FIG. 11 is a magnified schematic diagram that illustrates a portion of tracks 101 through 111 of a magnetic recording medium 3 according to a third embodiment of the present invention. The magnetic recording medium 3 of the third embodiment is a bit pattern medium (BPM), in which a great number of physically isolated magnetic dots 65, each for recording a single bit of data, are regularly arranged within data regions 11.

In the BPM 3 as well, the data regions 11 and the servo regions 12 are alternately provided in the circumferential direction, in a manner similar to the magnetic recording media 1 and 2 of the first and second embodiments.

As illustrated in FIG. 11, the magnetic dots 65 are separated and isolated by a non magnetic material 66.

The servo regions of the BPM 3 are regions in which servo data are recorded in advance as patterns of protrusions and recesses, in the same manner as in the DTM 2. Here, a magnetic material is embedded in recesses which are formed in a non magnetic material.

A plurality of bursts 67 are provided in burst portions 12c within the servo regions. Each of the bursts 67 is constituted by a first signal region 61 and second signal regions 68a and 68b. The first signal region 61 includes a first edge 61a that extends across a plurality of data tracks and intersects with the down track direction X and the cross track direction Y, and a second edge 61b that extends across the plurality of data tracks and is not parallel with the first edge 61a. The second signal regions 68a and 68b are provided adjacent to the first signal region 61 in the down track direction.

In the magnetic recording medium of the third embodiment, the first signal regions 61 are polygons in the shape of isosceles triangles with truncated acute angle corners. In addition, in the third embodiment, the burst portion includes a first burst string 62 and a second burst string 63 provided toward the down track side of the first burst string 62. In the first and second burst strings 62 and 63, the bursts 67 are arranged with one track intervals therebetween in the cross track direction. The second burst string 63 is provided with a constant offset in the cross track direction with respect to the first burst string 62, so as to cover discontinuous portions among the bursts 67 of the first burst string 62 (the position from track 105 to track 107 in FIG. 11, for example), that is, to cover PES signals for tracks in which positions between adjacent first signal regions 61 of the first burst string 62 are present.

In the BPM 3, the second signal regions indicated by the non hatched portions (white regions) are formed by a non magnetic material, and the first signal regions 61 indicated by hatching are formed by a magnetic material which is embedded in recesses formed in the non magnetic material. The magnetic material that forms the first signal regions 61 is magnetized in a predetermined direction in advance. The direction of magnetization is uniform within each individual burst 67. However, the direction of magnetization may be different among different bursts. Different signals can be obtained from the magnetic regions and the non magnetic regions by a magnetic head that performs scanning.

The magnetic head can derive the amount that it is off track, from integrated values (corresponding to differences in the hatched regions and the non hatched regions within scanned rectangles), when the magnetic head performs scanning from the edge 61b for a length L₇ of the bottom edge of the isosceles triangle (the length of the burst 67 in the down track direction), in the same manner as in the magnetic recording media 1 and 2 of the first and second embodiments.

The BPM 3 may also employ first signal regions having the shapes in plan view illustrated in any of FIG. 2 through FIG. 8.

As described above, the first signal regions of the bursts that constitute the burst pattern of the magnetic recording medium of the present invention are of large shapes that have widths that straddle a plurality of servo tracks, and lengths of a plurality of data bits. Therefore, the sizes of individual protrusions and recesses can be made large. The sizes of the protrusions (or recesses) corresponding to the first signal regions of the bursts in a transfer master carrier can be made large, and the pattern is that in which the shapes of the protrusions (or recesses) are not complex. Therefore, production of magnetic transfer master carriers and imprinting molds is facilitated. In addition, accurate production of magnetic recording media using these transfer master carriers is facilitated.

### Transfer Master Carrier According to a Fourth Embodiment (Magnetic Transfer Master Carrier)

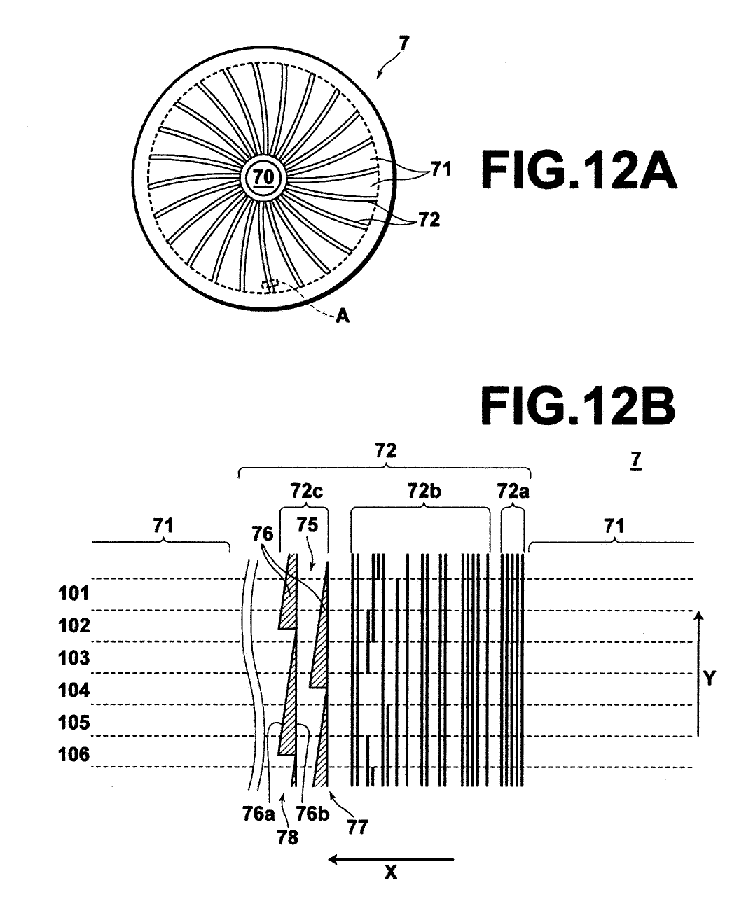

FIG. 12A is a plan view that illustrates a magnetic transfer master carrier 7 according to a fourth embodiment of the present invention. FIG. 12B is a magnified diagram that illustrates a portion of the magnetic transfer master carrier 7.

As illustrated in FIG. 12A, the magnetic transfer master carrier 7 of the fourth embodiment is formed as a discoid shape having a central aperture 70. A fine pattern of protrusions and recesses corresponding to data to be transferred is formed in an annular region that excludes the inner and outer peripheral portions on a surface of the magnetic transfer master carrier 7. Here, a case will be described in which the magnetic transfer master carrier 7 is equipped with a pattern of protrusions and recesses for forming magnetized patterns within the servo regions 12 of the magnetic recording medium 1.

The magnetic transfer master carrier 7 is equipped with servo protrusion/recess pattern regions 72, in which transfer servo patterns are formed as patterns of protrusions and recesses, that correspond to the servo regions 12 of the magnetic recording medium 1. Regions 71 among the servo protrusion/recess pattern regions 72 correspond to the data regions 11 of the magnetic recording medium 1.

FIG. 12B is a magnified view of portion A of FIG. 12A, and illustrates a region corresponding to the portion of the magnetic recording medium 1 illustrated in FIG. 2. A preamble portion 72a, for synchronizing a reproduction signal clock; an address portion 72b, in which servo signal discriminating codes, sector data, cylinder data, etc. are formed; and a burst portion 72c, in which burst patterns for detecting positional errors are formed, are provided in the servo protrusion/recess pattern region 72. In the servo protrusion/recess pattern region 72, the regions indicated by hatching are formed either as protrusions or as recesses.

As illustrated in FIG. 12B, a burst pattern 75 of the magnetic transfer master carrier 7 of the fourth embodiment is constituted by triangles 76 (the hatched regions), of which the lengths in the down track direction increase gradually in the cross track direction, including first edges 76a that extend across a plurality of data tracks and intersect with the down track direction X and the cross track direction Y, and second edges 76b that extend across the plurality of data tracks and are not parallel with the first edges 76a. The triangles 76 are the upper surfaces (or openings) of protrusions (or recesses). Here, the lengths of the protrusions (or recesses) 76 in the down track direction refer to the distances between the first edges 76a and the second edges 76b of the upper surfaces (or the openings) at the same position in the cross track direction (the same position in the radial direction).

In the transfer burst pattern illustrated in FIG. 12B, the protrusions 76 (or recesses 76) are arranged such that they correspond to the arrangement of the first signal regions 21 of the burst 20 of the magnetic recording medium 1 illustrated in FIG. 2.

As the sizes of the first signal regions 21 on the magnetic recording medium 1 become greater, the protrusions 76 (or recesses 76) provided corresponding thereto can be formed at larger sizes in the magnetic transfer master carrier 7, which is preferable.

The magnetic transfer master carrier 7 is mainly constituted by a substrate 7a and a magnetic layer 7b formed on the surface of the substrate 7a. The substrate 7a has the fine pattern of protrusions and recesses on the surface thereof, and the magnetic layer 7b is formed uniformly over the entire surface of the fine pattern of protrusions and recesses. In the fourth embodiment, the magnetic layer 7b is also in the recesses, from the viewpoint of ease of manufacture and the like. However, the magnetic layer needs only to be provided on the surfaces of the protrusions, and the magnetic layer 7b is not necessary in the recesses. It is preferable for the master carrier 7 to additionally have a protective layer, a lubricating layer, a backing layer, etc.

### (Production of the Magnetic Transfer Master Carrier)

An electron beam resist liquid is coated on a Si substrate having a smooth surface by a spin coat method or the like, to form a resist layer. An electron beam, which is modulated according to the aforementioned servo signals, is irradiated onto the resist layer while the Si substrate is rotated on a rotating stage. Thereby, the entire resist layer is irradiated with the electron beam, to expose a pattern corresponding to servo signals that extend linearly in the radial direction from the rotational center across each track, for example, by lithography.

The resist layer is developed, and the exposed (lithographed) portions are removed. Then, selective etching is performed by reactant ion etching or the like, using a coating layer of a desired thickness constituted by the remaining resist layer. Next, the resist layer is removed to obtain an original plate having a pattern of protrusions and recesses.

Thereafter, a conductive layer is formed at a uniform thickness on the surface of the original plate. A metal plate of a desired thickness is laminated onto the original plate by electrocasting a metal (Ni, for example). The metal plate is removed from the original plate, to obtain the substrate 7a, which has a pattern of protrusions and recesses inverse that of the original plate.

Next, the magnetic layer 7b is formed on the surface of the substrate 7a having the pattern of protrusions and recesses thereon. Finally, the inner and outer diameters of the substrate 7a are punched out to a predetermined size. The master carrier 7 having the pattern of protrusions and recesses, on which the magnetic layer 7b is provided, can be produced by the process described above.

### (Magnetic Transfer Method)

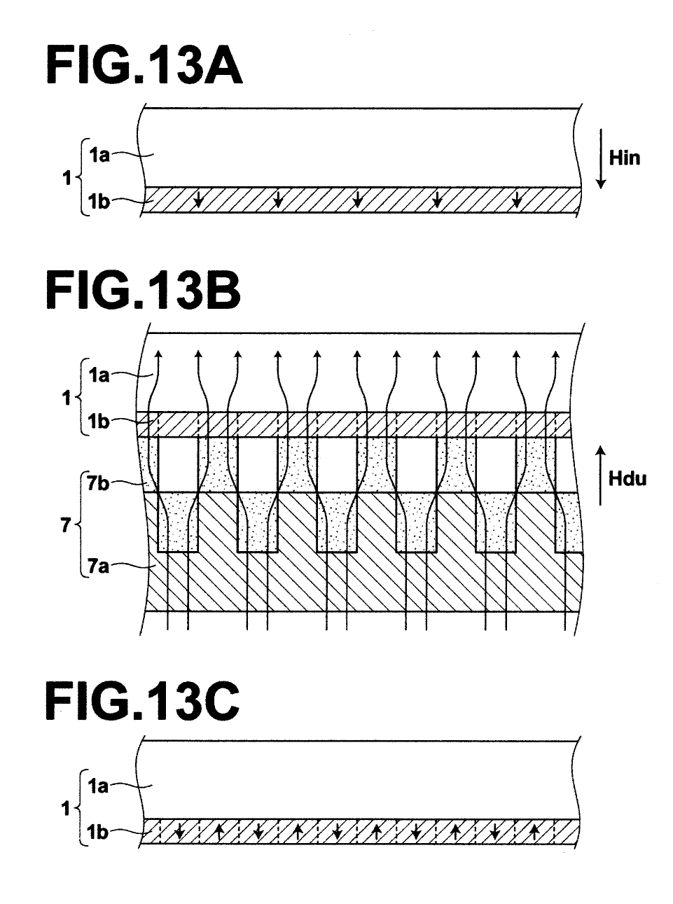

Next, the method by which the aforementioned magnetic transfer master carrier 7 for magnetic transfer is employed to record the transfer pattern onto the magnetic recording medium 1 having a magnetic layer 1b which is a vertical magnetic recording layer will be described. FIGS. 13A, 13B, and 13C are diagrams for explaining the steps of magnetic transfer.

As illustrated in FIG. 13A, the magnetic layer 1b of the magnetic recording medium 1 is initially DC magnetized in advance, by applying a DC initial magnetic field Hᵢₙ in one track direction. Then, as illustrated in FIG. 13B, the surface of the magnetic recording medium 1 having the magnetic layer 1b thereon is brought into close contact with the surface of the master carrier 7 having the magnetic layer 7b thereon, and a transfer magnetic field H_{du} is applied in the direction opposite to that of the initial DC magnetic field Hᵢₙ. The transfer magnetic field is absorbed by the protrusions of the magnetic layer 7b of the master carrier 7, as illustrated in FIG. 13C. The magnetization of the magnetic layer 1b of the magnetic recording medium 1 at the positions corresponding to the protrusions of the master carrier 7 is inverted, whereas the magnetization at other positions is not inverted. As a result, data (servo signals, for example) corresponding to the pattern of protrusions and recesses of the master carrier 7 are magnetically transferred and recorded onto the magnetic layer 1b of the magnetic recording medium 1 as a magnetized pattern.

### Transfer Master Carrier According to a Fifth Embodiment (Imprinting Mold)

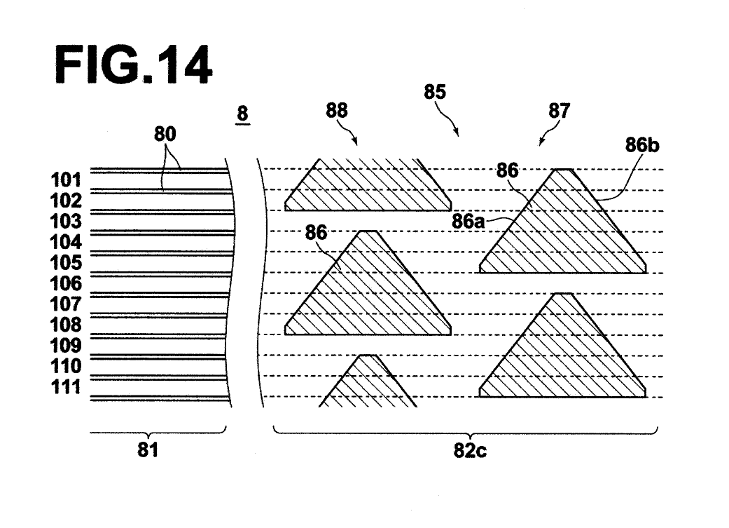

An imprinting mold 8 for DTM will be described as a transfer master carrier according to a fifth embodiment of the present invention. FIG. 14 is a magnified diagram that schematically illustrates a portion of the imprinting mold 8.

The imprinting mold 8 is of substantially the same shape as the magnetic transfer master carrier, and has a fine pattern of protrusions and recesses corresponding to data to be transferred on the surface thereof. In the fifth embodiment, the imprinting mold 8 has a fine pattern of protrusions and recesses corresponding to servo patterns and grooves to be formed on DTM.

The imprinting mold 8 is equipped with servo protrusion/recess pattern regions 82, in which transfer servo patterns are formed as patterns of protrusions and recesses, that correspond to the servo regions 12 of the DTM 2, and groove pattern regions 81, in which protrusions 80 that correspond to grooves that separate data tracks are formed.

FIG. 14 illustrates a region corresponding to the portion of the DTM 2 illustrated in FIG. 10. A burst portion 82c is provided in a servo protrusion/recess pattern region. A transfer burst pattern 85 constituted by protrusions 86 having upper surfaces in shapes of which the lengths in the down track direction gradually increase in the cross track direction. The upper surfaces of the protrusions 86 include first edges 86a that extend across a plurality of data tracks and intersect with the down track direction X and the cross track direction Y, and second edges 86b that extend across the plurality of data tracks and are not parallel with the first edges 86a.

In the transfer burst pattern 85 illustrated in FIG. 14, the protrusions 86 are arranged such that they correspond to the arrangement of the first signal regions 51 of the bursts of the bust pattern 50 of the DTM 2 illustrated in FIG. 10.

In the imprinting mold 8 as well, as the sizes of the first signal regions 51 on the DTM 2 become greater, the protrusions 86 provided corresponding thereto can be formed at larger sizes, which is preferable.

### (Production of the Imprinting Mold)

The steps for producing the original plate for the imprinting mold are substantially the same as those for the magnetic transfer master carrier. However, during the electron beam lithography step, groove patterns corresponding to grooves in the data regions are drawn in addition to the patterns corresponding to servo signals.

After producing an original plate having a pattern of protrusions and recesses thereon by a method similar to that for producing the original plate for the magnetic transfer master carrier, the original plate is pressed against a light transmitting substrate (a quartz substrate, for example) having an imprint resist layer formed thereon by coating imprint resist liquid thereon. Thereby, the pattern of protrusions and recesses formed on the original plate is transferred onto the imprint resist layer.

Ultraviolet rays are irradiated onto the imprint resist layer to cure the pattern transferred thereon.

Thereafter, the substrate is etched using the transferred resist pattern as a mask and then the resist is removed, to obtain the imprinting mold 8, which has a fine pattern of protrusions and recesses formed on the surface thereof.

### (Imprint Lithography)

Next, the method by which the imprinting mold 8 is employed to produce the DTM 2 will be described.

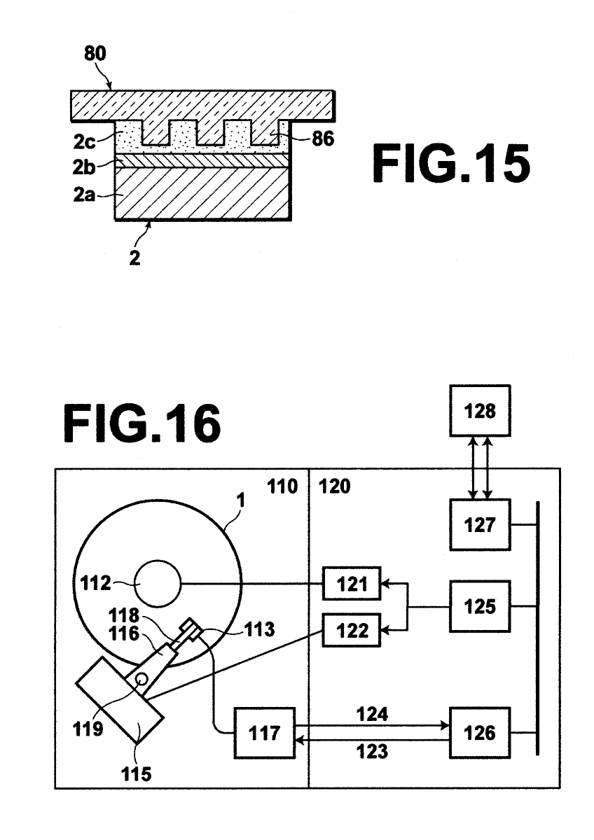

As illustrated in FIG. 15, the fine pattern of protrusions and recesses on the imprinting mold 8 is pressed against an imprint resist layer 2c of a substrate 2a, which is coated with a magnetic layer 2b and the imprint resist layer 2a. Then, pressure is applied, to transfer the pattern of protrusions and recesses of the imprinting mold 8 onto the imprint resist layer 2c.

Thereafter, the magnetic layer 2b is etched by RIE etching or the like, using the imprint resist layer 2c having the pattern of protrusions and recesses formed thereon as a mask. Thereby, a pattern of protrusions and recesses is formed on the magnetic layer 2b. Then, non magnetic materials are embedded in the recesses, the surface is flattened, and a protective film and the like are formed as necessary, to obtain the DTM 2.

Note that the above description is for production of DTM. However, BPM can be produced by a similar process.

The imprinting mold described above and the method for producing the discrete track medium using the imprinting mold are merely examples. The present invention is not limited to the production method described above.

In the case that magnetic recording media are preformatted with servo data are produced by employing transfer master carriers, such as magnetic transfer master carriers and imprinting molds, bearing servo data as patterns of protrusions and recesses, the patterns of protrusions and recesses corresponding to bust patterns having the bursts, which are recorded on the magnetic recording media of the present invention, are constituted by comparatively large protrusions or recesses. Therefore, the production of the transfer master carriers is facilitated. Particularly, the burst patterns illustrated in FIG. 8 and FIG. 10, which do not include acute angles, and the burst patterns illustrated in FIG. 10 and FIG. 11, in which the bursts are arranged to be separated from adjacent bursts, are favorable for the imprinting method that forms servo patterns of magnetic recording media by transferring patterns of protrusions and recesses.

### <Magnetic Recording Apparatus>

FIG. 16 is a diagram that illustrates the schematic structure of a magnetic record reproducing apparatus, for loading the magnetic recording medium 1 according to the first embodiment of the present invention therein. Alternatively, the magnetic recording medium loaded in the magnetic recording apparatus may be a DTM or a BPM.

The magnetic recording apparatus of the present embodiment is equipped with the aforementioned magnetic recording medium 1, a casing 110 for housing the magnetic recording medium 1, and a circuit board 120.

In order to perform servo tracking using the burst pattern of the magnetic recording medium 1, the magnetic recording apparatus has: a storage section, in which integrated burst signal value data for on track states are stored for each track; and a comparing section, for comparing the stored integrated burst signal value data against integrated signal values (integrated values) obtained by scanning the magnetic recording medium with a magnetic head. These sections are provided within the circuit board 120.

The casing 110 houses: the magnetic recording medium 1; an actuator 115 constituted by a spindle motor 112 (SPM), a magnetic head 113, and a voice coil motor (VCM, not shown); a head gimbal assembly 118; a carriage arm 116; a shaft 119; and a head amplifier 117, in a sealed state. The magnetic recording medium 1 is mounted on the SPM 112. The magnetic head 113 includes a recording (write) element (not shown) for recording magnetic data onto the magnetic recording medium 1, and a reproduction (read) element (not shown) for reading out magnetic data recorded in the magnetic recording medium 1 as electrical signals. The head end of the head gimbal assembly 118 at which the magnetic head 113 is not mounted is fixed to the tip of the carriage arm 116. The carriage arm 116 is capable of being driven by the VCM in a swinging manner, with the shaft 119 as the rotational axis thereof. The magnetic head 113 is enabled to scan the magnetic recording medium 1 in the approximate radial direction thereof by this swinging motion. The magnetic head 113 can write data into data tracks of the magnetic recording medium 1, or read data from the magnetic recording medium 1, by being positioned on desired data tracks of the magnetic recording medium 1. The head amplifier 117 functions to record onto the magnetic recording medium 1 by causing current to flow to the recording element of the magnetic head 113, based on recording signals 123, and to convert magnetic data recorded on the magnetic recording medium 1 detected by the reproducing element of the magnetic head 113 into reproduction signals 124.

The circuit board 120 includes: a read channel 126; a micro processing unit 125 (MPU 125); a spindle motor (SPM) driver 121; a voice coil motor (VCM) driver 122; a disk controller 127; and the like. The read channel 126 has the functions of decrypting and converting reproduction signals 124 (servo signals or data signals) from the head amplifier 117 into digital signals, and converting data instructed to be recorded by the disk controller 127 into recording signals 123 for driving the head amplifier 117.

The MPU 125 drives the VCM driver 122 to exert control over the positioning of the magnetic head 113, based on digital data (servo data) which are decrypted by the read channel 126, or drives the

SPM driver 121 to exert control over the rotation of the magnetic recording medium 1. The MPU 125 includes a comparing section, which reads out stored signal values for an on track state for a desired track from a storage section (not shown), and for comparing the stored integrated burst signal value data against integrated signal values obtained by scanning magnetic recording media with the magnetic head 113, to perform servo tracking.

The disk controller 127 issues commands to position the magnetic head 113 to the MPU 125 based on a recording/reproducing command from a host computer 128m and functions to perform addressing of the magnetic head 113 with respect to the magnetic recording medium 1. In addition, the disk controller 127 functions to perform transmission and reception of digital data to be recorded and reproduced by the read channel 126, and transmits the results to the host computer 128.

Positional data regarding the magnetic head 113 are obtained from magnetic patterns that constitute servo patterns within servo regions 12 while the magnetic recording medium 1 is being rotated. The magnetic head 113 is positioned with respect to tracks based on output signals obtained from the magnetic head, and data is enabled to be recorded into desired positions of the data regions 11.

The magnetic recording apparatus of the present invention is equipped with the magnetic recording medium having burst pattern constituted by bursts having high continuity. Therefore, highly accurate PES signals can be obtained, to perform accurate servo tracking.

What is claimed is:

1. A magnetic recording medium equipped with a servo pattern, to be utilized in a magnetic recording apparatus that employs a servo method to detect the scanning position of a magnetic head in the radial direction of magnetic recording media, based on integrated values obtained from burst patterns within servo patterns of magnetic recording media, comprising
the servo pattern; and
the burst pattern including bursts within the servo pattern;
each burst being a rectangular region constituted by a first signal region formed across a plurality of data tracks and is of a shape in which the length in the down track direction increases substantially linearly in the cross track direction, and one or two second signal regions adjacent to the first signal region in the down track direction, the maximum length of the first signal region being an edge of the rectangular region; and
a plurality of the bursts being provided in the cross track direction.

2. A magnetic recording medium as defined in claim 1, wherein:
the shape of the first signal region includes a first edge that intersects with the down track direction and the cross track direction, and a second edge that extends across the plurality of data tracks and is not parallel with the first edge.

3. A magnetic recording medium as defined in claim 1, wherein:
a plurality of the bursts are provided in the down track direction.

4. A magnetic recording medium as defined in claim 3, wherein:
the plurality of the bursts provided in the down track direction are provided such that bursts which are adjacent to each other in the down track direction are offset in the cross track direction.

5. A magnetic recording apparatus, comprising:
a magnetic head;
a storage section, in which integrated burst signal value data for on track states are stored for each track;
a comparing section, for comparing the stored integrated burst signal value data against integrated signal values obtained by scanning magnetic recording media with the magnetic head; and
a magnetic recording medium as defined in claim 1.

6. A transfer master carrier equipped with a pattern of protrusions and recesses on the surface thereof as a transfer servo pattern, for forming a servo pattern for a magnetic recording medium as defined in claim 1, wherein:
the transfer servo pattern includes one of a recess and a protrusion corresponding to the first signal region of the burst of the magnetic recording medium, having a shape in plan view in which the length in the down track direction gradually increases in the cross track direction, across a plurality of data tracks of the magnetic recording medium.
